(19) United States
(12) Patent Application Publication
(10) Pub. No.: US 2025/0319767 A1
(43) Pub. Date: Oct. 16, 2025

(54) DRIVE DEVICE FOR A WORKING MACHINE

(71) Applicant: ZF Friedrichshafen AG, Friedrichshafen (DE)

(72) Inventors: Samuel Willems, Albstadt (DE); Raphael Himmelsbach, Friedrichshafen (DE); Stefan Igl, Vilshofen (DE); Manfred Auer, Schardenberg (AT); Gerhard Grömmer, Fuerstenzell (DE); Martin Sagmeister, Passau (DE); Stefan Windpassinger, Sonnen (DE)

(73) Assignee: ZF Friedrichshafen AG, Friedrichshafen (DE)

(21) Appl. No.: 18/866,224

(22) PCT Filed: May 9, 2023
(86) PCT No.: PCT/EP2023/062232

§ 371 Date: Nov. 15, 2024

(30) Foreign Application Priority Data
May 16, 2022 (DE) 10 2022 204 738.9

(51) Int. Cl. B60K 17/28; B60K 1/02; B60K 17/02; B60K 17/04; B60K 17/08; B60K 17/344; B60K 17/354; B60K 17/356; B60K 25/00

(52) U.S. Cl. CPC B60K 17/28; B60K 1/02; B60K 17/02; B60K 17/046; B60K 17/08; B60K 17/344; B60K 17/354; B60K 17/356; B60K 25/00; B60K 2025/005

(57) ABSTRACT

A drive device for a working machine includes a first electric machine with a first motor shaft, a second electric machine with a second motor shaft, a first drive output shaft, a first power take-off shaft, and a second power take-off shaft. A transmission has an input shaft, an output shaft, a driving planetary gearset with a sun gear, a planetary carrier, and a ring gear, a driving shifting element, and a brake, where the sun gear is permanently connected rotationally fixed to the input shaft, and the planetary carrier is connected rotationally fixed to the output shaft. The first motor shaft can be connected to the first drive output shaft via the transmission. The second motor shaft can be connected to the first power take-off shaft and to the second power take-off shaft. The ring gear can be immobilized and the driving planetary gearset can be blocked.

### RELATED APPLICATIONS

This application claims the benefit under 35 U.S.C. § 371 as a U.S. National Phase Application of application No. PCT/EP2023/062232, filed on 9 May 2023, which claims the benefit of German Patent Application no. 10 2022 204 738.9 filed on 16 May 2022, the contents of which are hereby incorporated herein by reference in their entireties.

### TECHNICAL FIELD

The present invention relates to a drive device for a working machine, which comprises two electric motors.

### BACKGROUND

Drive devices for working machines are required to enable efficient and reliable operation of the working machine with a variety of ground conditions and working cycles. If the working machine is powered purely by an internal combustion engine, complex, expensive, and bulky mechanical components, and alternatively or in addition, hydraulic components are needed.

### SUMMARY

A first aspect of the invention relates to a drive device for a working machine. A drive device can be part of a drivetrain, for example. The working machine can be an agricultural machine such as a tractor, a building machine or even a special vehicle. Examples of a working machine are a wheel loader and a tractor, in which particular wheels can be driven by a drive power of the drive device. Often, attachments are mounted on working machines, which can also be powered by the working machine. For that purpose, the working machine can have a power take-off.

The drive device comprises a first electric machine with a first motor shaft. The first electric machine is designed to deliver a first drive power to the first motor shaft. The drive device has a second electric machine with a second motor shaft. The second electric machine is designed to deliver a second drive power to the second motor shaft. For example, each electric machine has only one motor shaft. The description “second motor shaft” serves only to associate that shaft with the second electric machine.

The electric machines can be designed to convert electrical energy into mechanical energy. Optionally, each electric machine can be designed to operate in recuperation mode. For example, an electric machine can be in the form of an asynchronous motor or a synchronous motor. For example, the drive device comprises an energy source such as a rechargeable battery. By virtue of the energy source the two electric machines can be supplied with current for their operation. The drive device can comprise an associated inverter for each electric machine, which controls a drive power output of the electric machine. Each electric machine of the drive device can also have an associated energy source.

The drive device comprises a first drive output shaft. For example, part of the drive power produced by the electric motors can be delivered to the first drive output shaft, and from there for example to an associated drive axle of the working machine. The first drive output shaft can be, for example, functionally connected to a rear axle of the working machine. A drive output shaft can be, for example, mechanically and functionally connected to the associated drive axle of the working machine by way of an axle differential. Alternatively, or in addition, for example a mechanical functional connection by way of respective bevel gears is possible. A drive output shaft can form an output shaft of the drive device. The drive device can be designed to transmit a drive power from the first motor shaft to the first drive output shaft.

The first motor shaft can be mechanically and functionally connected to the first drive output shaft by way of a driving transmission. The driving transmission can be designed to engage different gear ratios between the first motor shaft and the first drive output shaft. The driving transmission can also be designed to interrupt torque transmission from the first motor shaft to the first drive output shaft, for example in a particular shift condition. In that way idling can take place.

The drive device comprises a first power take-off shaft and a second power take-off shaft. Power can be drawn from one power take-off shaft. For example, the first power take-off shaft can be designed as the front power take-off shaft. The second power take-off shaft can be designed as the rear power take-off. By way of each power take-off shaft, for example, accessory equipment can be supplied with mechanical power by the drive device. For example, the drive device can be designed to drive the power take-off shaft with an essentially constant rotation speed, for example one of two predetermined power take-off shaft rotation speeds. Alternatively, or in addition the drive device can be designed to drive the power take-off shafts with variable rotation speeds. The drive device can be designed, optionally, to deliver drive power to one of the two, or to both power take-off shafts.

The second motor shaft can be mechanically and functionally connected to the first power take-off shaft and to the second power take-off shaft. For example, in a first shift condition the second motor shaft can be mechanically and functionally connected only to the first power take-off shaft. For example, in a second shift condition the second motor shaft can be mechanically and functionally connected only to the second power take-off shaft. For example, in a third shift condition the second motor shaft can be mechanically and functionally connected to both the first and the second power take-off shafts. For example, in a fourth shift condition the second motor shaft can be mechanically and functionally connected to neither of the two power take-off shafts. Thus, in the fourth shift condition the second electric machine can drive auxiliary equipment such as hydraulic pumps without driving attached devices or either of the two power take-off shafts. In the fourth shift condition, therefore, the second electric machine in certain design versions can alternatively or in addition drive a drive output shaft without driving any attached devices.

The driving transmission comprises an input shaft, an output shaft, a driving planetary gearset, a driving shifting element, and a brake. The driving planetary gearset comprises a sun gear, a planetary carrier, and a ring gear. A driving planetary gearset can be in the form of a normal planetary gearset and is, for example, only so designated for assignment purposes. A planetary gearset can comprise only three rotating elements, for example. As rotating elements, a planetary gearset comprises a sun gear, a planetary carrier, and a ring gear. One or more planetary gearwheels can be mounted to rotate on the planetary carrier. For example, the driving planetary gearset can be in the form of a minus planetary gearset. In a minus planetary gearset respective planetary gearwheels mesh with both the sun gear and the ring gear. For example, the driving planetary gearset can also be in the form of a plus planetary gearset, in which two sets of planetary gearwheels are mounted to rotate on the planetary carrier. These planetary gearwheels then mesh in pairs with one another. One of the planetary gearwheels in each pair additionally meshes with the sun gear and the other of the planetary gearwheels of each pair additionally meshes with the ring gear. The driving shifting element is, for example, in the form of a frictional shifting element. The term driving shifting element serves to assign its function. Driving shifting elements can be designed like other shifting elements. The brake of the driving transmission can be a shifting element by means of which a rotary element of a planetary gearset can be immobilized against a stationary component. The brake can be, for example, in the form of a frictional shifting element.

The sun gear of the driving planetary gearset is permanently connected rotationally fixed to the input shaft of the driving transmission. The planetary carrier of the driving planetary gearset is permanently connected and rotationally fixed to the output shaft of the driving planetary gearset. The ring gear of the driving planetary gearset can be immobilized by means of the first brake of the driving transmission, for example by a rotationally fixed connection to a stationary component of the drive device. The driving planetary gearset can be blocked by means of the driving shifting element. For the blocking, the driving shifting element can be designed to connect two rotary elements of the second planetary gearset rotationally fixed to one another. In the blocked condition all the rotary elements of a planetary gearset rotate at the same angular speed.

This produces a very compact driving transmission with which two gear ratios of high efficiency can be provided, which are very suitable for working machines. By virtue of the blocking, in the gear ratio for the highest driving speed losses due to the meshing of respective gears in the driving transmission can be avoided. Thus, in the case of high power demands, operation at particularly high efficiency is enabled. Furthermore, the driving transmission can enable idling.

With the drive device, use can be made of the fact that compared with a drive device only with an internal combustion engine, electric machines can enable more flexible utilization of the structural space available in the working machine. Thereby the working machine can now have two power take-off shafts, such that only one or both power take-off shafts can be operationally driven. In that way two accessory devices can be used, or at least attached at the same time. For example, the two accessory devices are driven only by the second electric machine. Thus, even with an otherwise very largely equivalent mechanical structure compared to a working machine having only an internal combustion engine, no additional motor for driving the second power take-off shaft has to be provided. There can be an additional power interface for the second power take-off shaft. The drive of the two power take-off shafts can be integrated in a central drive unit.

The drive device can comprise a first power take-off transmission and alternatively or in addition a second power take-off transmission. A power take-off transmission can be designed to produce a mechanical and functional connection between a power take-off shaft and an attached device, for example with different gear ratios. Thus, even with a common drive for the two power take-off shafts, the first power take-off shaft can have a rotation speed different from that of the second power take-off shaft. Moreover, it can in that way be made possible to operate the second electric machine at a particularly efficient operating point. For example, each power take-off transmission can be designed to provide two different gear ratios.

The drive device can be designed to be extended in a modular manner. In that way a standard drive device can be adapted to suit different customer specifications. Examples of modular extensions emerge from the embodiments described in what follows. The modular extension of the drive device can take place before fitting into the working machine. In another embodiment the modular extension can take place even after the installation of the drive device in the working machine.

When two elements are functionally connected, they are coupled directly or indirectly to one another in such manner that a movement of one element brings about a reaction of the other element. For example, a mechanical and functional connection can be produced by an interlocking or frictional connection. In a mechanical and functional connection, one or more spur gear stages can be involved in the transmission of drive power. For example, the mechanical and functional connection can correspond to the meshing of the respective teeth of two elements. Between the two elements further elements such as one or more spur gear stages can be provided.

A permanent rotationally fixed connection of two elements is understood to mean a connection by virtue of which, to all intents and purposes, the two elements are essentially connected solidly to one another. This also includes a frictional connection, however, with which desired or undesired slip can take place. Elements permanently connected to one another in a rotationally fixed manner can take the form either of individual components connected rotationally fixed to one another, or even integrally made components.

A connection of one element by way of a further element can mean that the further element participates in an indirect functional connection of the two elements. For example, that element can be arranged in the power flow between the two elements. A connection of two elements by way of two or more further elements can mean that the further elements all participate in an indirect functional connection of the two elements.

A shiftable connection can enable torque to be transmitted between two elements in one condition, for example via a firm coupling, while in another condition the torque transmission is essentially interrupted. For that purpose, an appropriate shifting element can be provided between the two elements.

If a torque can be transmitted from one element to another element, for that purpose it may be necessary to actuate a shifting element, for example in order to produce a mechanical functional connection. However, if a torque can be transmitted from one element to another element, for all intents and purposes that can be possible in any condition of the drive device, i.e., independently of any shift condition of any shifting elements.

A spur gear stage can be, for example, in single-stage or multi-stage form. For example, a single-stage spur gear stage can comprise two spur gears that mesh with one another. A two-stage spur gear stage can comprise, for example, three gearwheels that mesh with one another in pairs.

A shifting element can be, for example, of frictional or interlocking design. An example of a frictional shifting element is a disk clutch. An example of an interlocking shifting element is a claw-type clutch. A shifting element can be closed, for example, by actuating it. For example, a shifting element can be actuated by oil pressure in order to enable torque to be transferred between two elements. For that purpose, a shifting element can be designed such that in one shift condition it interrupts a mechanical functional connection between two elements. A shifting element can also be designed as a dual shifting element which optionally connects a first element to a second or to a third element. Optionally, a dual shifting element can have a neutral position. The drive device can comprise a control unit for controlling the shifting elements and thereby engaging specific operating modes.

In a further embodiment of the drive device, it is provided that the drive device comprises a power take-off intermediate shaft and a first spur gear stage. The power take-off intermediate shaft can be mechanically and functionally connected to the first power take-off shaft by means of a first power take-off shifting element. For example, the power take-off intermediate shaft can be connected to the first power take-off shaft by means of the first power take-off shifting element in a rotationally fixed manner. The power take-off intermediate shaft can be mechanically and functionally connected to the second power take-off shaft by means of a second power take-off shifting element. For example, the power take-off intermediate shaft can be connected to the second power take-off shaft by means of the second power take-off shifting element in a rotationally fixed manner. The second motor shaft can be mechanically and functionally connected to the power take-off intermediate shaft by way of the first spur gear stage. Thus, only one output shaft, and alternatively or in addition, one power interface is needed for the second electric machine in order to be able to drive the two power take-offs selectively. A simple and space-saving design can be produced. The term “power take-off shifting element” serves to denote its function. Power take-off shifting elements can be in the same form as other shifting elements. For example, both power take-off shifting elements can be frictional in order to enable starting and alternatively or in addition to enable the connection of one of the two power take-off shafts when the other power take-off shaft is already being driven by the power take-off intermediate shaft.

The drive device can comprise an internal combustion engine with an internal combustion-engine shaft, which is designed to deliver a combustion-engine drive power to the combustion-engine shaft. The internal combustion engine can be, for example, a diesel engine. The internal combustion engine shaft can be, for example, mechanically and functionally connectable to the power take-off intermediate shaft by means of a combustion-engine shifting element. For example, the combustion-engine shaft can be mechanically and functionally connected to the power take-off intermediate shaft by means of the combustion-engine shifting element. The term “combustion-engine shifting element” serves to denote its function. Combustion-engine shifting elements can be in the same form as other shifting elements. For example, the combustion-engine shifting element can be a frictional shifting element. For example, the first power take-off shaft can be mechanically and functionally connectable to the power take-off intermediate shaft by way of the combustion-engine shaft, the combustion-engine shifting element and the first power take-off shifting element. For example, the first power take-off shaft can be connected rotationally fixed to the combustion-engine shaft by means of the first power take-off shifting element. Thus, the internal combustion engine can drive one or both power take-off shafts alone or together with the second electric machine. In total, in that way a particularly high take-off power is made possible. However, for example, the internal combustion engine need not be operating and yet the first power take-off can be driven by the second electric machine by way of the combustion-engine shaft. The internal combustion engine can also drive the second electric machine in order to generate current for an energy storage device or for the first electric machine. The second electric machine then functions as a generator. The combustion-engine shaft can for example extend through the internal combustion engine so as to enable a connection of other elements to its two axial ends.

In a further embodiment of the drive device, it is provided that the drive device comprises a second drive output shaft. The second drive output shaft can be, for example, mechanically and functionally connected to a front axle of the working machine. The drive device can be designed such that a drive power is transmitted from the first motor shaft to the second drive output shaft. By virtue of the second drive output shaft the drive device can provide all-wheel driving.

The drive device can be designed to transfer a torque from the first drive output shaft to the second drive output shaft. Thus, in a simple manner an unregulated all-wheel drive can be provided. Furthermore, in a simple manner the drive power can be transmitted to both drive output shafts by way of the driving transmission. The second drive output shaft can be mechanically and functionally connected to the first drive output shaft. However, the second drive output shaft can also be mechanically and functionally connectable to the first drive output shaft. For example, the drive device can comprise an all-wheel spur gear stage and an all-wheel shifting element so that the first drive output shaft can be mechanically and functionally connected to the second drive output shaft via the all-wheel spur gear stage by way of the all-wheel shifting element. The terms “all-wheel shifting element” and “all-wheel spur gear stage” serve to denote their function. The all-wheel shifting element can be designed in the same way as other shifting elements and the all-wheel spur gear stage in the same way as other spur gear stages. For example, the all-wheel shifting element is frictional and the all-wheel spur gear stage has a single stage.

In a further embodiment of the drive device, it is provided that the drive device comprises an all-wheel spur gear stage, an all-wheel shifting element, an additional power shifting element, and a third electric machine with a third motor shaft, which machine is designed to deliver a third drive power to the third motor shaft. The third motor shaft can be mechanically and functionally connected to the second drive output shaft by way of the additional power shifting element. The first drive output shaft can be mechanically and functionally connected to the second drive output shaft via the all-wheel spur gear stage by way of the all-wheel shifting element. In that way the third electric machine can support the first electric machine during driving operation with the all-wheel drive activated. When driving with the all-wheel drive the driving efficiency may be lower, so that higher power may be needed. The third electric machine can then supply that power without the first electric machine correspondingly having to be designed for only rarely occurring peak loads while driving with the all-wheel drive. Moreover, by dividing the power between the first electric machine and the third electric machine, the fitting space available can be, for example, used efficiently and alternatively or in addition very flexibly.

In a further embodiment of the drive device, it is provided that the drive device comprises a summing gear system, a brake, and a third electric machine with a third motor shaft, which machine is designed to supply a third drive power to the third motor shaft. A summing gear system, for example, can comprise a plurality of input shafts and one output shaft to which the drive power supplied to the input shafts is conjointly delivered. The summing gear system can be, for example, in the form of a planetary gearset. A brake can be a shifting element by means of which a rotating element can be immobilized against a stationary component. The brake can be, for example, in the form of a frictional shifting element. The planetary gearset can comprise a sun gear, a planetary carrier, and a ring gear. One or more planetary gearwheel(s) can be mounted to rotate on the planetary carrier. The planetary gearset is, for example, in the form of a minus planetary gearset. In a minus planetary gearset each planetary gearwheel meshes with the ring gear and also with the sun gear. A torque can be transmitted from the third motor shaft to a first input shaft of the summing gear system. The first input shaft of the summing gear system can be, for example, in the form of the sun gear. The first drive output shaft can be mechanically and functionally connected to a second input shaft of the summing gear system. Correspondingly, the second input shaft of the summing gear system can be mechanically and functionally connected to the first motor shaft by way of the driving transmission and the first drive output shaft. The second input shaft of the summing gear system can be, for example, in the form of a hollow shaft. An output shaft of the summing gear system can be permanently connected rotationally fixed to the second drive output shaft. For example, the output shaft of the summing gear system can be in the form of a planetary carrier. By means of the third electric machine a gear ratio of the summing gear system can in that way be changed. A regulated all-wheel drive is obtained, optionally also in power-branched form. The first input shaft of the summing gear system can be immobilized by means of the brake. In that way a solid all-wheel drive can be engaged, which can be particularly efficient. When the solid all-wheel drive is in use, for example the third electric machine can be deactivated.

In a further embodiment of the drive device, it is provided that the drive device comprises a motor coupling shifting element. The term “motor coupling shifting element” serves to denote its function. Motor coupling shifting elements can be designed in the same way as other shifting elements. For example, the respective motor coupling elements are frictional. The first motor shaft can be mechanically and functionally connected by the motor coupling shifting element to the second motor shaft, for example by way of a spur gear stage. In this case the functional connection can also take place at least partially via a spur gear stage, by way of which the first motor shaft can be mechanically and functionally connected to the first drive output shaft. The motor coupling shaft can be, for example, arranged coaxially on the power take-off intermediate shaft so that the first motor shaft can be mechanically and functionally connected to the power take-off intermediate shaft by means of the motor coupling shifting element. Thanks to the motor coupling shifting element, the first electric machine can support the second electric machine when driving the power take-off shafts. By virtue of the motor coupling shifting element, the second electric machine can support the first electric machine when driving the drive output shafts. There are new operating modes. Furthermore, the respective electric machines can be made smaller since usually, when the power take-off load is at a maximum, driving takes place only at low speed or the working machine is at a standstill. Likewise, it is usual that at maximum driving speed no power take-off load or only a small power take-off load is needed. Moreover, in that way a ground-speed power take-off function can also be provided.

In a further embodiment of the drive device, it is provided that the drive device comprises a first motor coupling shifting element and a second motor coupling shifting element. The third motor shaft can be mechanically and functionally connected to the second motor shaft by means of the first motor coupling shifting element. The first motor shaft can be mechanically and functionally connected to the third motor shaft by means of the second motor coupling shifting element. Thus, for example, the third electric machine can support the second electric machine independently of the first electric machine. The first electric machine can, for example, only support the second electric machine when that is also possible by the third electric machine or when the first motor coupling shifting element is closed. To connect the first motor shaft mechanically and functionally to the second motor shaft, the first motor coupling shifting element and the second motor coupling shifting element, for example, must both be closed. By virtue of its function the first motor coupling shifting element can therefore correspond to the motor coupling shifting element described in the previous embodiment. Thanks to the two motor coupling elements, the first electric machine and the third electric machine can both support the second electric machine when driving the power take-off shafts. Furthermore, the third electric machine can also support the second electric machine alone when driving the power take-off shafts, while the first electric machine only powers the driving of the working machine. Thanks to two motor coupling shifting elements, the second electric machine can also support the first electric machine when driving the drive output shafts. There are new operating modes and a ground-speed power take-off function.

In a further embodiment of the drive device, it is provided that the drive device comprises a working hydraulics supply device, a system hydraulics supply device, and an auxiliary electric machine with an auxiliary motor shaft. An auxiliary electric machine can be designed the same way as a normal electric machine. For example, compared with the first and second electric machines and also optionally with other electric machines described herein, the auxiliary electric machine can be essentially less powerful. The auxiliary motor shaft can be a normal motor shaft, which has been so designated solely to denote its function. The working hydraulics supply device can be designed to supply a working hydraulics system with pressure. With the working hydraulics system, for example, particular tools of the working machine such as a scoop can be actuated. A working hydraulics supply device can for example comprise a constant-displacement pump and an adjustable pump which are powered in common by a shaft. However, a working hydraulics supply device can comprise, for example, only an adjustable pump. The system hydraulics supply device can be designed to supply particular control hydraulics with pressure. For example, the system hydraulics supply device can deliver a transmission oil pressure and a pressure for actuating particular shifting elements of the drive device. The system hydraulics supply device can also comprise only a constant-displacement pump. The system hydraulics supply device and the working hydraulics supply device can be separate devices. Respective oil circuits supplied by them can be fluidically separate at least within a pressure range. The system hydraulics supply device can be, for example, mechanically and functionally connected to the second motor shaft by means of a spur gear stage via the power take-off intermediate shaft.

For example, during the operation of the working machine the auxiliary electric machine can always be operated at a predetermined minimum rotation speed in order to enable the actuation of particular shifting elements. Thus, when the working machine is operating in certain operating conditions the second electric machine remain at rest, which can be more efficient. Furthermore, a module consisting of the auxiliary electric machine and the system hydraulics supply device can enable flexible utilization of the available structural space independently of other components of the drive device. In addition, the second electric machine can be made less powerful. Thus, the auxiliary electric machine and the second electric machine can be operated particularly efficiently, for example, more rarely at inefficient operating points during the usual working cycles of the working machine. The auxiliary motor shaft can be permanently connected rotationally fixed to an input shaft of the system hydraulics supply device. Thus, a module designed in that way can have no shifting elements and spur gear stages. If, in contrast, the system hydraulics supply device is powered by the second electric machine, then for example, during the operation of the working machine the second electric machine can be operated at a predetermined minimum rotation speed in order to enable the actuation of particular shifting elements.

In a further embodiment of the drive device, it is provided that the drive device comprises a working hydraulics supply device and a system hydraulics supply device. The second motor shaft can be mechanically and functionally connected to the working hydraulics supply device and to the system hydraulics supply device. There is then no need for an auxiliary electric machine. Thus, for example, the drive device can be particularly compact and can require fewer electric machines. With this design, when the working machine is operating the second electric machine can always b operated at a minimum rotation speed.

In a further embodiment of the drive device, it is provided that the drive device comprises a second spur gear stage. The working hydraulics supply device can be permanently connected rotationally fixed to a shaft of the first spur gear stage. The working hydraulics supply device can be arranged in the torque flow from the second drive power before the power take-off intermediate shaft. The system hydraulics supply device can be mechanically and functionally connected to the second motor shaft by way of the first spur gear stage and the second spur gear stage. Particularly efficient rotation speed ratios can be obtained, even though the second electric machine is powering both the system hydraulics supply device and the working hydraulics supply device. The first spur gear stage and the second spur gear stage can have a common gearwheel, which for example is permanently connected rotationally fixed to the power take-off intermediate shaft. In that way the drive device can have particularly few gearwheels.

In a further embodiment of the drive device, it is provided that the first motor shaft can be mechanically and functionally connected to the second motor shaft by means of the motor coupling shifting element via the second spur gear stage. Thus, for example, there is no need for an additional spur gear stage or at least for additional gearwheels in order to be able to couple the first motor shaft to the second motor shaft. Instead, a mechanical functional connection between the first motor shaft and the second motor shaft can make use of the second spur gear stage. Alternatively, or in addition, the drive device can in that way be axially very compact. The motor coupling shifting element can be, for example, arranged coaxially with an input shaft of the system hydraulics supply device. A very compact structure can be obtained.

In a further embodiment of the drive device, it is provided that the planetary carrier can be connected rotationally fixed to the sun gear by means of the driving shifting element. In that way, in a simply designed manner the planetary gearset can be blocked by the driving shifting element. For example, no additional hollow shafts are needed for that.

In a further embodiment of the drive device, it is provided that the driving planetary gearset is in the form of a minus planetary gearset. A simply designed and efficient driving transmission with gear ratio steps particularly suitable for working machines can be produced.

A further aspect relates to a working machine. The working machine comprises a drive device according to the first aspect. Particular advantages and further features emerge from the description of the first aspect, such that design features of the first aspect are also design features of the second aspect, and vice-versa.

The working machine comprises a drive axle and in a further embodiment additionally another drive axle. A torque can be transmitted from the first drive output shaft to the first drive axle. A torque can be transmitted from the second drive output shaft, if present, to the further drive axle. The drive axle is for example in the form of a rear axle of the working machine. The further drive axle is for example in the form of the front axle of the working machine. On each drive axle, for example at opposite ends, wheels are arranged. Each drive axle can comprise an axle differential and alternatively or in addition a wheel transmission for each wheel. The working machine can have a driving brake, for example arranged on the rear axle. The working machine can also have a driving brake for each drive axle.

### BRIEF DESCRIPTION OF THE DRAWINGS

FIG. 1: A schematic illustration of a first embodiment of a drive device for a working machine with two electric machines and a driving transmission.

FIG. 2: A schematic illustration of a second embodiment of a drive device for a working machine, which additionally comprises an internal combustion engine.

FIG. 3: A schematic illustration of a third embodiment of a drive device for a working machine, in which compared with the first embodiment the electric machines are connected differently.

FIG. 4: A schematic illustration of a fourth embodiment of a drive device for a working machine, in which compared with the first embodiment a working hydraulics supply device and a system hydraulics supply device are connected differently.

FIG. 5: A schematic illustration of a fifth embodiment of a drive device for a working machine, in which a first motor shaft and a second motor shaft can be mechanically and functionally connected to one another.

FIG. 6: A schematic illustration of a sixth embodiment of a drive device for a working machine, in which the first motor shaft and the second motor shaft can be mechanically and functionally connected to one another otherwise than in the fifth embodiment.

FIG. 7: A schematic illustration of a seventh embodiment of a drive device for a working machine, which comprises an auxiliary electric machine by means of which the system hydraulics supply device can be driven.

FIG. 8: A schematic illustration of an eighth embodiment of a drive device for a working machine, which comprises a third electric machine by means of which a second drive output shaft can additionally be powered.

FIG. 9: A schematic illustration of a ninth embodiment of a drive device for a working machine, in which compared with the eighth embodiment the motor shafts can be connected differently.

FIG. 10: A schematic illustration of a tenth embodiment of a drive device for a working machine, which comprises a third electric machine and a summing gear system in order to provide a controllable all-wheel drive of power-branched design.

FIG. 11: A schematic illustration of an eleventh embodiment of a drive device for a working machine, in which compared with the tenth embodiment the third motor shaft can be mechanically and functionally connected to the second motor shaft and the first motor shaft can be mechanically and functionally connected to the third motor shaft.

### DETAILED DESCRIPTION OF EMBODIMENTS

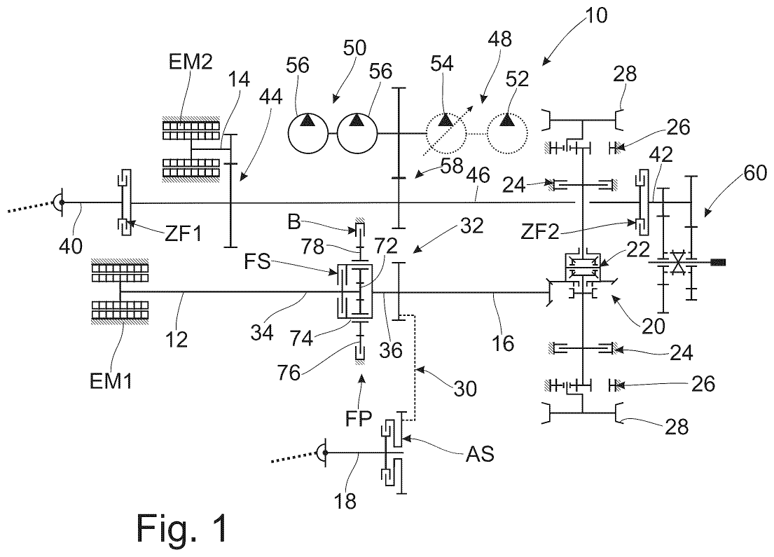

FIG. 1 shows a schematic illustration of a drive device 10 of a working machine. The drive device 10 comprises a first electric machine EM1 with a first motor shaft 12, which machine is designed to deliver a first drive power to the first motor shaft 12. The drive device 10 comprises a second electric machine EM2 with a second motor shaft 14, which machine is designed to deliver a second drive power to the second motor shaft 14. In the example of the first embodiment shown, the two electric machines EM1 and EM2 are designed to have the same rotation speed and have essentially the same power. The drive device comprises a first drive output shaft 16 and a second drive output shaft 18. The first drive output shaft 16 is mechanically and functionally connected to a rear axle 20. The rear axle 20 comprises an axle differential 22, a driving brake 24 on both sides, a wheel transmission 26 on both sides and a wheel 28 on both sides. By means of the first drive output shaft 16 the rear axle 20 can be driven in order to propel the working machine. The second drive output shaft 18 is mechanically and functionally connected to a front axle (not shown). The second drive output shaft 18 can be mechanically and functionally connected to the first drive output shaft 16 via an all-wheel spur gear stage 30 by means of an all-wheel shifting element AS. Thus, a solid all-wheel drive can be engaged in order to power the working machine for driving by the rear axle 20 and the front axle together.

The first motor shaft 12 can be mechanically and functionally connected via a driving transmission 32 to the first drive output shaft 16. The driving transmission 32 comprises an input shaft 34 which is mechanically and functionally connected to the first motor shaft 12. In the first embodiment of the drive device 10, for that purpose the input shaft 34 of the driving transmission 32 is permanently connected rotationally fixed to the first motor shaft 12. The driving transmission 32 has an output shaft 36, which is permanently connected rotationally fixed to the first drive output shaft 16. In addition, the driving transmission 32 has a driving planetary gearset FP, a driving shifting element FS and a brake B. The driving planetary gearset FP comprises a sun gear 72, a planetary carrier 74 and a ring gear 76, and is in the form of a minus planetary gearset. On the planetary carrier 74 a plurality of planetary gearwheels 78 are mounted to rotate, each of which meshes both with the sun gear 72 and with the ring gear 76.

The sun gear 72 is permanently connected rotationally fixed to the input shaft 34 of the driving transmission 32. The planetary carrier 74 is permanently connected rotationally fixed to the output shaft 36 of the driving transmission 32. By means of the brake B of the driving transmission 32 the ring gear 76 can be connected rotationally fixed to a stationary component of the drive device 10 and thereby immobilized. The driving planetary gearset FP can be blocked by means of the driving shifting element FS, in that the planetary carrier 74 can be connected rotationally fixed to the sun gear 72. Thus, with a very compact structure two gear ratio steps can be provided by the driving transmission 32. Since the brake B is built into it, the driving transmission 32 is also inexpensive. Furthermore, at high driving speeds the driving transmission 32 is also very efficient due to the blocking of the driving planetary gearset.

The drive device comprises a first power take-off shaft 40 and a second power take-off shaft 42. The first power take-off shaft 40 is designed as a front power take-off. The second power take-off shaft 42 is designed as a rear power take-off shaft. A two-step power take-off transmission 60 is connected to the second power take-off shaft 42. A further power take-off transmission (not shown) is connected to the first power take-off shaft 40. With the two power take-off shafts 40, 42 two attached devices can be supplied with tapped power. For that purpose, the second motor shaft 14 is mechanically and functionally connected to the first power take-off shaft 40 and to the second power take-off shaft 42. The second motor shaft 14 is mechanically and functionally connected by way of a first spur gear stage 44 to a power take-off intermediate shaft 46. The power take-off intermediate shaft 46 can be connected rotationally fixed at its front end to the first power take-off shaft 40 by a first power take-off shifting element ZF1. The power take-off intermediate shaft 46 can be connected at its rear end to the second power take-off shaft 42 by a second power take-off shifting element ZF2.

The drive device 10 has a working hydraulics supply device 48 and a system hydraulics supply device 50. The working hydraulics supply device 48 comprises a constant-displacement pump 52 and an adjustable pump 54. The working hydraulics supply device 48 is designed to supply a working hydraulics system with pressure in order to be able to actuate a tool hydraulically. The system hydraulics supply device 50 has two constant-displacement pumps 58. The system hydraulics supply device 50 is designed to supply a system pressure for actuating the shifting elements of the drive device 10 and for actuating a steering system, as well as a transmission oil pressure. The system hydraulics supply device 50 and the working hydraulics supply device 48 are jointly mechanically and functionally connected to the second motor shaft 14 by way of a spur gear stage 58 via the power take-off intermediate shaft 46 and the first spur gear stage 44. During the operation of the working machine the second electric machine EM2 in this first embodiment always runs at a minimum rotation speed in order to supply a minimum system pressure.

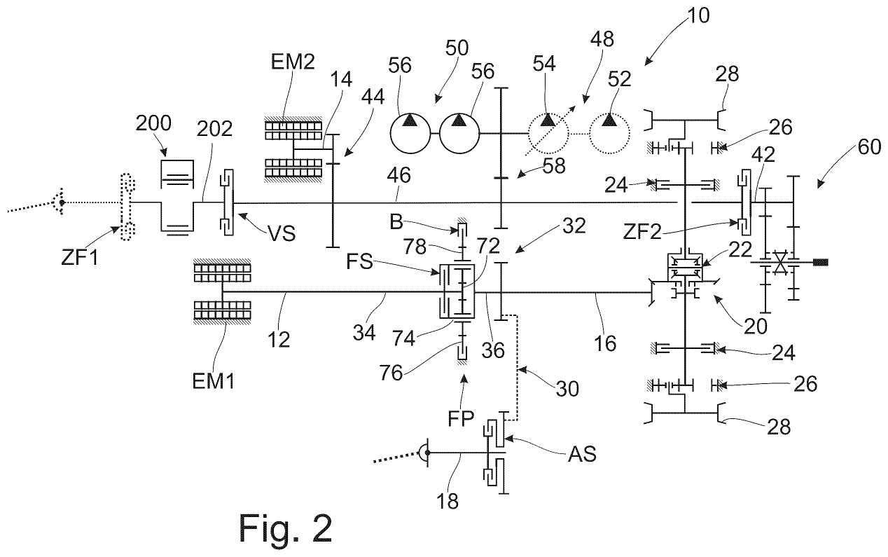

FIG. 2 shows a second embodiment of the drive device 10, which is similar to the first embodiment. Accordingly, only the differences will be described.

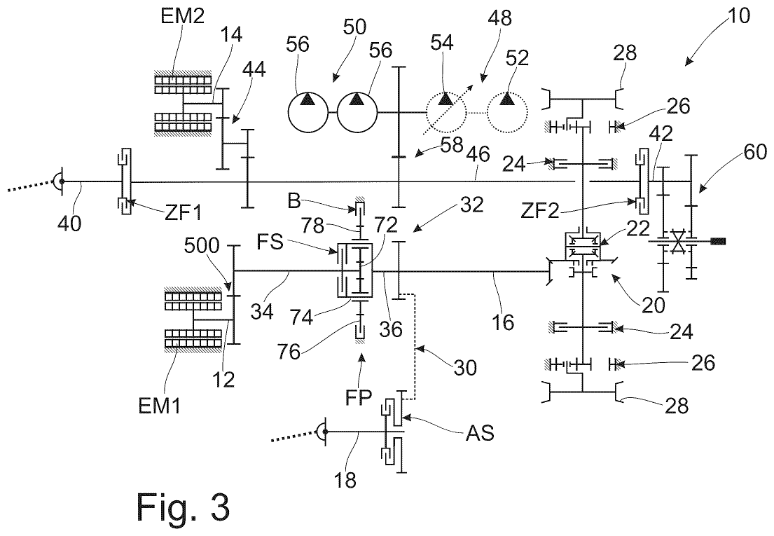

In the second embodiment of the drive device 10, an internal combustion engine 200 is additionally provided, with an internal combustion engine shaft 202 that extends axially through the internal combustion engine 200. The internal combustion engine shaft 202 can be connected rotationally fixed to the power take-off intermediate shaft 46 by means of a combustion-engine shifting element VS. Thus, the second electric machine EM2 can be operated as a generator by means of the internal combustion engine 200. The first power take-off shaft 40 can be connected rotationally fixed to the combustion-engine shaft 202 by means of the first power take-off shifting element ZF1. Thus, the first power take-off shaft 40 can be driven by the internal combustion engine 200 and also, when the combustion-engine shifting element VS is closed, by the second electric machine EM2. In other embodiments, which are shown in FIGS. 3 to 11, the internal combustion engine 200 can also be provided.

FIG. 3 shows a third embodiment of the drive device 10, which is similar to the first embodiment. Accordingly, only the differences will be described.

In the third embodiment the first motor shaft 12 is not mechanically and functionally connected to the input shaft 34 in a permanent and rotationally fixed manner, but by way of a single-step spur gear stage 500. The first spur gear stage 44 which connects the second motor shaft 14 mechanically and functionally to the power take-off intermediate shaft 46, is a two-step spur gear stage in this third embodiment instead of a single-step spur gear stage as in the first embodiment.

Owing to the additional gear ratio, compared with the first embodiment, in this third embodiment the two electric machines EM1, EM2 can be designed for a higher rotation speed level. Thereby, in the third embodiment the two electric machines EM1, EM2 are radially more compact. In contrast, in the first embodiment the two electric machines EM1, EM2 are axially shorter.

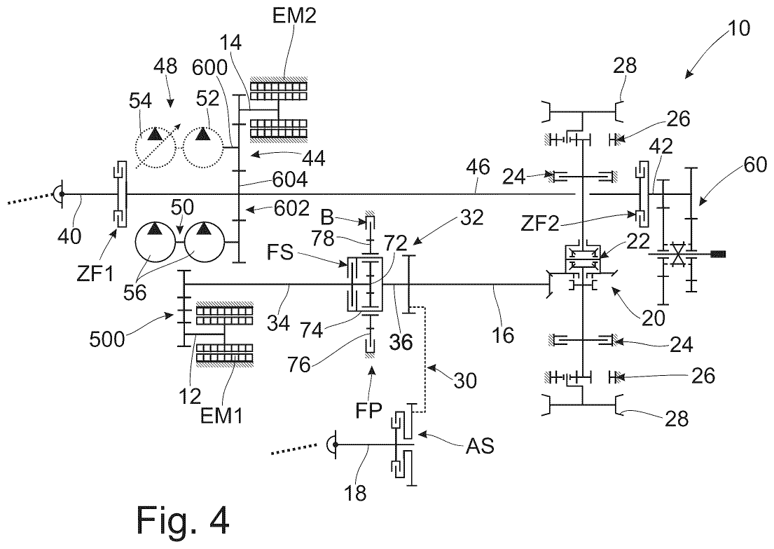

FIG. 4 shows a fourth embodiment of the drive device 10, which is similar to the third embodiment. Accordingly, only the differences will be described.

In the fourth embodiment, the working hydraulics supply device 48 is permanently connected rotationally fixed to a shaft 600 of the two-step first spur gear stage 44. The system hydraulics supply device 50 is mechanically and functionally connected to the second motor shaft 14 by way of the first spur gear stage 44 and a second spur gear stage 602. The first spur gear stage 44 and the second spur gear stage 602 have a common gearwheel 604 which is connected permanently and rotationally fixed to the power take-off intermediate shaft 46. Furthermore, the spur gear stage 500 that connects the first motor shaft 12 to the input shaft 34 of the driving transmission 32, is of multi-step design in this fourth embodiment of the drive device 10.

This results in closer radial nesting, so that the fourth embodiment of the drive device 10 is axially very short. In this case a radial fitting space is used, which in conventional working machines with an internal combustion engine is taken up by a fuel tank. Furthermore, the rotation speed levels at the working hydraulics supply device 48 and the system hydraulics supply device 50 are better. Accordingly, there is no need for two different gear ratio steps in the power take-off transmission 60. Thus, in the fourth embodiment the power take-off transmission 60 is in the form of a simple spur gear stage with no shifting element. In the fourth embodiment the second electric machine EM2 is designed for higher rotation speeds than the first electric machine EM1.

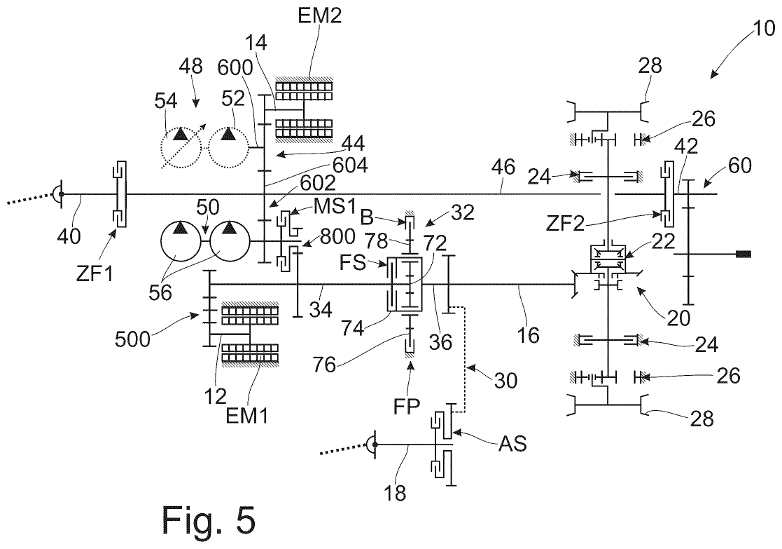

FIG. 5 shows a fifth embodiment of the drive device 10, which is similar to the fourth embodiment. Accordingly, only the differences will be described.

In the fifth embodiment of the drive device 10, a first motor coupling shifting element MS1 is additionally provided. The first motor shaft 12 can be mechanically and functionally connected to the second motor shaft 14 by means of the first motor coupling shifting element MS1. In the embodiment illustrated a first spur gear stage 700 is connected to a central shaft 702 of the spur gear stage 500 by means of which the first motor shaft 12 is mechanically and functionally connected to the input shaft 34 of the driving transmission 32. The first motor coupling shifting element MS1 is arranged on the power take-off intermediate shaft 46 and is designed to connect the spur gear stage 700 to the power take-off intermediate shaft 46.

Correspondingly, the first electric machine 12 and the second electric machine 14 can support one another when the two power take-off shafts 40, 42 and the two drive output shafts 16, 18 are operated. Thus, a total system power can be lower since the working machine does not usually have to provide a maximum power take-off power and a maximum driving power at the same time. In the example shown, the second electric machine EM2 is therefore designed with a lower maximum power than the first electric machine EM1. Correspondingly, in the fifth embodiment the second electric machine EM2 is particularly small. Moreover, in that way a ground-speed power take-off function is provided.

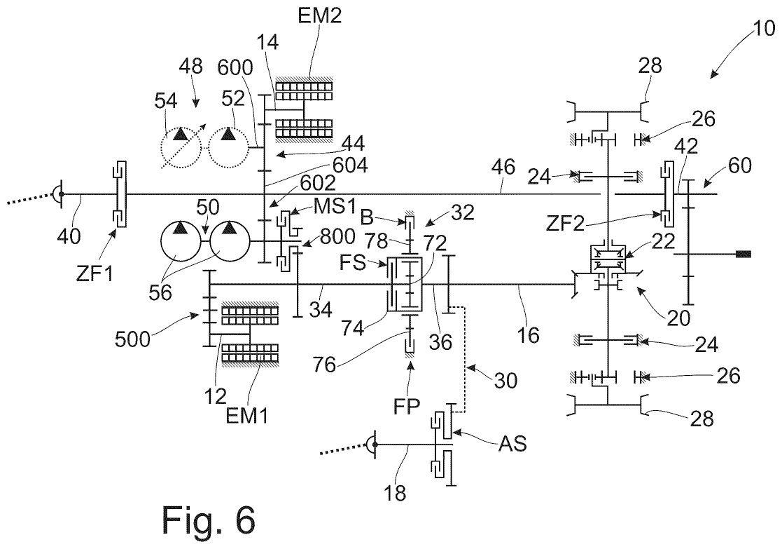

FIG. 6 shows a sixth embodiment of the drive device 10, which is similar to the fifth embodiment. Accordingly, only the differences will be described.

In the sixth embodiment of the drive device 10 the way that the first motor shaft 12 is mechanically and functionally connected to the second motor shaft 14 is different. The first motor coupling shifting element MS1 is arranged coaxially with a driveshaft of the system hydraulics supply device 50. Instead of the spur gear stage 700, which functionally connects the spur gear stage 500 to the power take-off intermediate shaft 46 in a shiftable manner, a spur gear stage 800 is provided. The spur gear stage 800 provides a mechanical functional connection between the input shaft 34 of the driving transmission 32 and the driveshaft of the system hydraulics supply device 50 when the motor coupling shifting element is closed. Correspondingly, the first motor shaft 12 can be mechanically and functionally connected to the second motor shaft 14 by means of the first motor coupling shifting element MS1 via the second spur gear stage 602. In that way the drive device 10 according to the sixth embodiment is made axially particularly short.

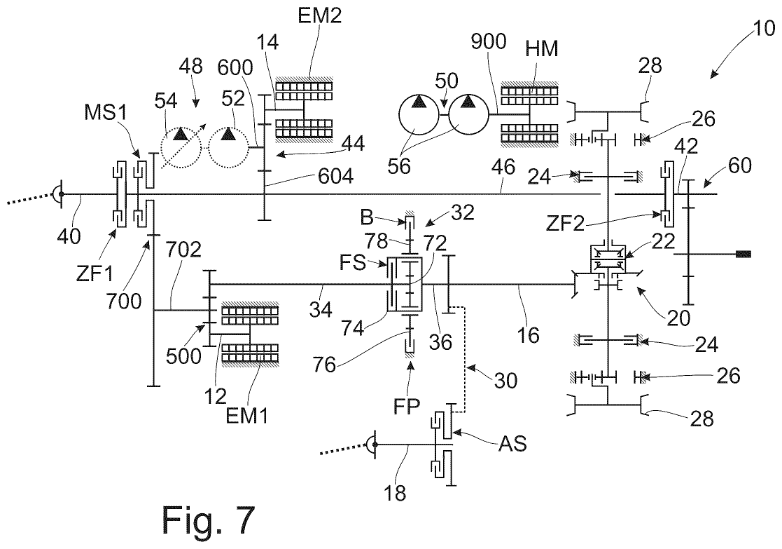

FIG. 7 shows a seventh embodiment of the drive device 10, which is similar to the fifth embodiment. Accordingly, only the differences will be described.

In the seventh embodiment of the drive device 10, the system hydraulics supply device 50 is not driven by the second electric machine EM2. Correspondingly, the second spur gear stage 602 is omitted. Instead, the seventh embodiment of the drive device 10 comprises an auxiliary electric machine HM with an auxiliary motor shaft 900. The auxiliary motor shaft 900 is mechanically and functionally connected to the system hydraulics supply device 50, since in the example shown the auxiliary motor shaft 900 is connected permanently and rotationally fixed to the system hydraulics supply device 50. In that way the system hydraulics supply device 50 can be arranged and driven independently. This improves the flexibility in the way structural space is used. Furthermore, in that way the second electric machine EM2 can be switched off when no power take-off power or support of the propulsion by the second electric machine EM2 is needed. Instead of the second electric machine EM2, the auxiliary electric machine HM is operated with a minimum rotation speed when the working machine is in operation. Thus, the second electric machine EM2 can be operated more frequently at an efficient operating point. The maximum power of the auxiliary electric machine HM is essentially lower than that of either of the two electric machines EM1, EM2.

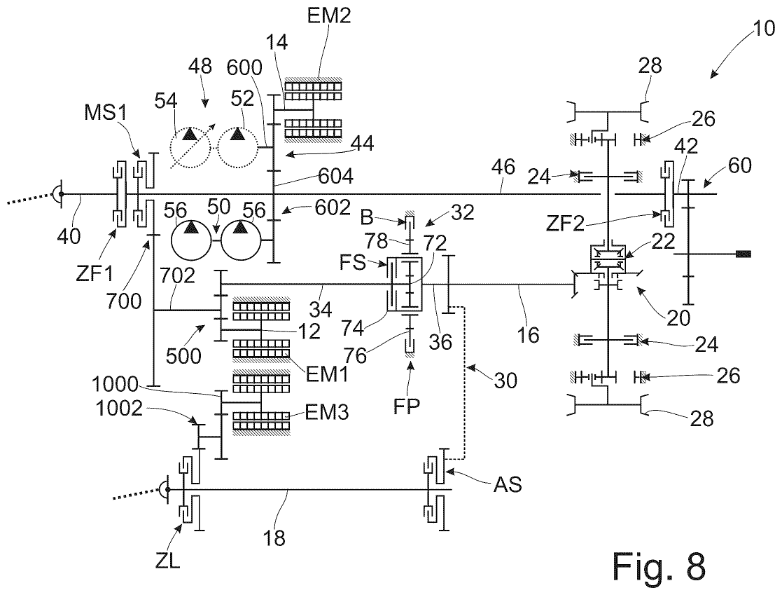

FIG. 8 shows an eighth embodiment of the drive device 10, which is similar to the fifth embodiment. Accordingly, only the differences will be described.

The eighth embodiment of the drive device 10 additionally comprises a third electric machine EM3 with a third motor shaft 1000. The third electric machine EM3 is designed to deliver a third drive power to the third motor shaft. The third motor shaft 1000 is mechanically and functionally connected to the second drive output shaft 18 by way of a spur gear stage 1002, in this case of multi-step design, via an additional power shifting element ZL. The third electric machine EM3 is designed to be less powerful than the first electric machine EM1.

In the eighth embodiment of the drive device 10, in addition to a fixed all-wheel function, a controllable all-wheel function can be provided. When the all-wheel shifting element AS is actuated, the two drive axles are driven with a fixed rotation speed ratio. By actuating the additional power shifting element ZL and with the all-wheel shifting element AS closed, the third electric machine EM3 can support the first electric machine EM1 when driving both the two power take-off shafts 40, 42 and also the two drive output shafts 16, 18. Correspondingly, the first electric machine in this embodiment can be designed to have lower power, whereby fitting space and costs can be saved. When the all-wheel shifting element AS is not actuated but the additional power shifting element ZL is actuated, the third electric machine EM3 can drive the second drive output shaft 18 independently of the first drive output shaft 16. Thus, a rotation speed ratio of the second drive output shaft 18 relative to the first drive output shaft 16 can be varied for a controllable all-wheel drive.

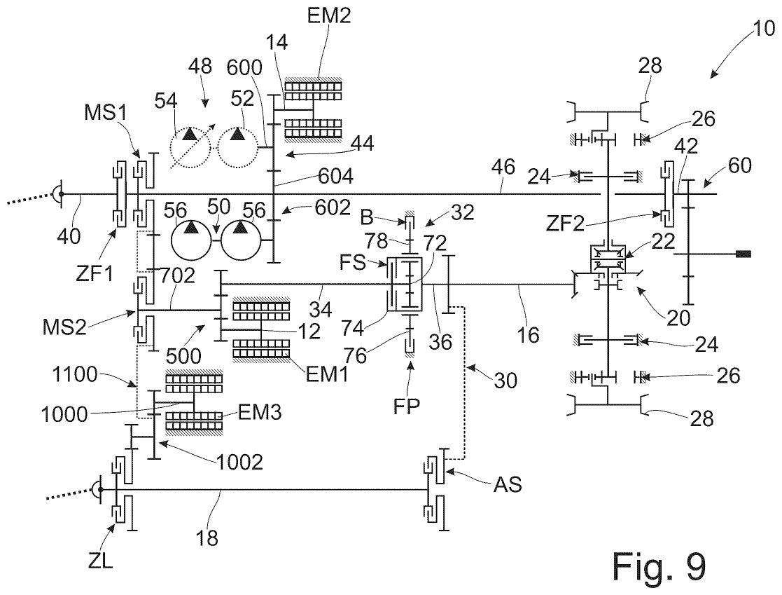

FIG. 9 shows a ninth embodiment of the drive device 10, which is similar to the eighth embodiment. Accordingly, only the differences will be described.

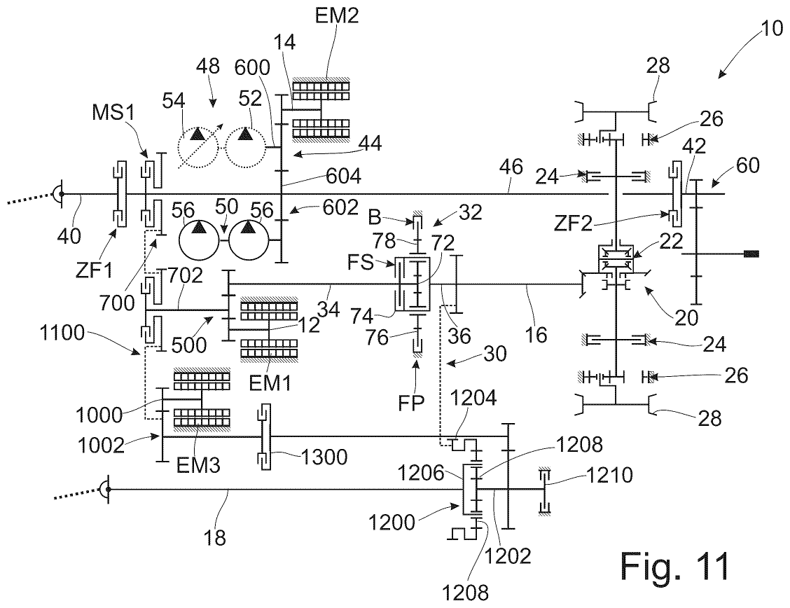

In the ninth embodiment the third motor shaft 1000 can be mechanically and functionally connected to the second motor shaft 14. The third motor shaft 1000 can be mechanically and functionally connected to the power take-off intermediate shaft 46 by means of a spur gear stage 1100 via the first motor coupling shifting element MS1. In the ninth embodiment the first motor shaft 12 can likewise be mechanically and functionally connected to the second motor shaft 14. For that purpose, a second motor coupling shifting element MS2 is provided, by means of which, in the embodiment shown in FIG. 11, the second motor shaft 14 can be connected mechanically to the third motor shaft 1000 via the spur gear stage 1100. Thus, when the first and second motor coupling shifting elements MS1, MS2 are both actuated, the drive power from the first electric machine EM1 can be transmitted to the power take-off intermediate shaft 46. Furthermore, the ninth embodiment enables an operating mode in which the third electric machine EM3 supports the second electric machine EM2 when driving the power take-off shafts, and the first electric machine EM1 drives a respective drive output shaft 16, 18 alone. In this operating mode the second motor coupling shifting element MS2 and the additional power shifting element ZL are not actuated, whereas the first motor coupling shifting element MS1 is actuated.

In the ninth embodiment the first electric machine EM1 and the third electric machine EM3 are designed such that only by both together can a maximum required drive power be provided. In that way the drive device 10 of the ninth embodiment is compact and inexpensive.

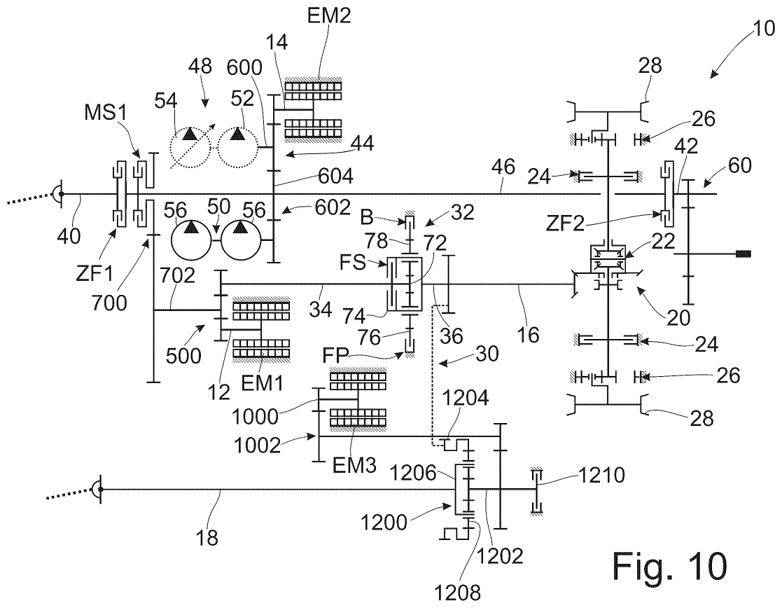

FIG. 10 shows a tenth embodiment of the drive device 10, which is similar to the eighth embodiment. Accordingly, only the differences will be described.

In the tenth embodiment the first electric machine EM1 and the third electric machine EM3 are connected in such manner that the drive device 10 is electrically power-branched and can provide a variable all-wheel drive. The additional power shifting element ZL is omitted. In addition, a summing gear system 1200 is provided, which is in the form of a minus planetary gearset with a sun gear 1202 as its first input shaft, a ring gear 1204 as its second input shaft, and a planetary carrier 1206 as its output shaft. On the planetary carrier planetary gearwheels are mounted to rotate, each of which meshes with both the sun gear 1202 and the ring gear 1204.

The third motor shaft 1000 is mechanically and functionally connected to the sun gear 1202 by the spur gear stage 1002. The first drive output shaft 16 is mechanically and functionally connected to the ring gear 1204 by the all-wheel spur gear stage 30, so that by way of the driving transmission 32 a torque can be transmitted from the first motor shaft 12 to the second input shaft of the summing gear system 1200. The planetary carrier is connected permanently and rotationally fixed to the second drive output shaft 18. Thus, with the third electric machine EM3 a gear ratio at the summing gear system 1200 can be varied. The third electric machine EM3 is designed for lower loads, since essentially it only varied the gear ratio.

The sun gear 1202 of the summing gear system 1200 can be immobilized by an additional brake 1210. In that way a fixed all-wheel drive can be provided, which enables efficient driving without support by the third electric machine EM3.

FIG. 11 shows an eleventh embodiment of the drive device 10, which is essentially a combination of the ninth embodiment with the tenth embodiment. Accordingly, only the differences will be described.

In the eleventh embodiment, the first motor coupling shifting element MS1 and the second motor coupling shifting element MS2 are again provided, as in the ninth embodiment. The third motor shaft 1000 can therefore be mechanically and functionally connected to the second motor shaft 14 by means of the first motor coupling shifting element MS1. The first motor shaft 12 can be mechanically and functionally connected to the third motor shaft 1000 by means of the second motor coupling shifting element MS2.

Furthermore, in the eleventh embodiment, the summing gear system is provided as provided in the tenth embodiment. The third motor shaft 1000 can be mechanically and functionally connected to the sun gear 1202 via the spur gear stage 1002 by means of an additional shifting element 1300. As in the tenth embodiment, the first drive output shaft 16 is mechanically and functionally connected to the ring gear 1204 via the all-wheel spur gear stage 30, so that by way of the driving transmission 32 a torque can be transmitted from the first motor shaft 12 to the second input shaft of the summing gear system 1200. The planetary carrier 1206 is permanently connected rotationally fixed to the second drive output shaft 18.

The additional shifting element 1300 makes it possible to separate the third motor shaft 1000 from the summing gear system 1200. Thereby, if the additional shifting element 1300 is not actuated the third electric machine EM3 can support the second electric machine EM2 when driving the power take-off shafts 40 and 42, while the first electric machine EM1 powers the drive output shafts 16 and 18 independently and without any influence of the third electric machine EM3 upon the gear ratio.

### INDEXES

10 Drive device
12, 14, 1000 Motor shafts
16, 18 Drive output shafts
20 Rear axle
22 Axle differential
24 Driving brake
26 Wheel transmission
28 Wheel
30 All-wheel spur gear stage
32 Driving transmission
34 Input shaft
36 Output shaft
40, 42 Power take-off shafts
44, 58, 500, Spur gear stages
602, 700, 800, Spur gear stages
1002, 1100 Spur gear stages
46 Power take-off intermediate shaft
48 Working hydraulics supply device
50 System hydraulics supply device
52, 56 Constant-displacement pump
54 Adjustable pump
60 Power take-off transmission
72 Sun gear of the driving transmission
74 Planetary carrier of the driving transmission
76 Ring gear of the driving transmission
78 Planetary gearwheels of the driving planetary gearset
200 Internal combustion engine
202 Motor shaft of the internal combustion engine
600 Shaft
604 Gearwheel
702 Central shaft
900 Auxiliary motor shaft
1200 Summing gear system
1202 Sun gear
1204 Ring gear
1206 Planetary carrier
1208 Planetary gearwheels
1210 Brake
1300 Shifting element
EM1 to EM3 Electric machines
HM Auxiliary electric machine
AS All-wheel shifting element
FP Driving planetary gearset
FS Driving shifting element
B Brake of the driving transmission
ZF1, ZF2 Power take-off shifting elements
V1 to V3 Gear ratio steps of the driving transmission
VS Combustion-engine shifting element
MS1, MS2 Motor coupling shifting elements
ZL Additional power shifting element

1. A drive device (10) for a working machine, comprising:
a driving transmission comprising an input shaft (34), an output shaft (36), a driving planetary gearset (FP) having a sun gear (72), a planetary carrier (74), and a ring gear (76), a driving shifting element (FS), and a brake (B), wherein the sun gear (72) is permanently connected rotationally fixed to the input shaft (34), wherein the planetary carrier (74) is permanently connected rotationally fixed to the output shaft (36), wherein the ring gear (76) can be immobilized by means of the brake (B), and wherein the driving planetary gearset (FP) can be blocked by means of the driving shifting element (FS);
a first electric machine (EM1) with a first motor shaft (12), the first electric machine configured to deliver a first drive power to the first motor shaft (12);
a second electric machine (EM2) with a second motor shaft (14), the second electric machine configured to deliver a second drive power to the second motor shaft (14); and
a first drive output shaft (16), a first power take-off shaft (40), and a second power take-off shaft (42), wherein the first motor shaft (12) can be mechanically and functionally connected to the first drive output shaft (16) by way of the driving transmission (32), and wherein the second motor shaft (14) can be mechanically and functionally connected to the first power take-off shaft (40) and to the second power take-off shaft (42).

2. The drive device (10) according to claim 1, comprising:
a power take-off intermediate shaft (46);
a first spur gear stage (44); and
a second power take-off shifting element (ZF2),
wherein the second motor shaft (14) is mechanically and functionally connected to the power take-off intermediate shaft (46) by means of the first spur gear stage (44),
wherein the power take-off intermediate shaft (46) can be mechanically and functionally connected to the first power take-off shaft (40) by means of a first power take-off shifting element (ZF1), and
wherein the power take-off intermediate shaft (46) can be mechanically functionally connected to the second power take-off shaft (42) by means of the second power take-off shifting element (ZF2).

3. The drive device (10) according to claim 2, comprising a second drive output shaft (18), wherein torque can be transmitted from the first drive output shaft (16) to the second drive output shaft (18).

4. Drive device (10) according to claim 3, comprising:
an all-wheel spur gear stage (30);
an all-wheel shifting element (AS);
an additional power shifting element (ZL); and
a third electric machine (EM3) with a third motor shaft (1000), the third electric machine configured to deliver a third drive power to the third motor shaft (1000);
wherein the third motor shaft (1000) can be mechanically and functionally connected to the second drive output shaft (18) by means of the additional power shifting element (ZL); and
wherein the first drive output shaft (16) can be mechanically and functionally connected to the second drive output shaft (18) via the all-wheel spur gear stage (30) by means of the all-wheel shifting element (AS).

5. The drive device (10) according to claim 3, comprising:
a summing gear system (1200);
a brake (1210); and
a third electric machine (EM3) with a third motor shaft (1000), the third electric machine configured to deliver a third drive power to the third motor shaft (1000);
wherein torque can be transmitted by the third motor shaft (1000) to a first input shaft (1202) of the summing gear system (1200);
wherein the first drive output shaft (16) is mechanically and functionally connected to a second input shaft (1204) of the summing gear system (1200);
wherein an output shaft (1206) of the summing gear system (1200) is permanently connected rotationally fixed to the second drive output shaft (18); and
wherein the first input shaft (1202) of the summing gear system (1200) can be immobilized by means of the brake (1210).

6. The drive device (10) according to claim 1, comprising a motor coupling shifting element (MS1), wherein the first motor shaft (12) can be mechanically and functionally connected to the second motor shaft (14) by means of the motor coupling shifting element (MS1).

7. The drive device (10) according to claim 4, comprising:
a first motor coupling shifting element (MS1); and
a second motor coupling shifting element (MS2);
wherein the third motor shaft (1000) can be mechanically and functionally connected to the second motor shaft (14) by means of the first motor coupling shifting element (MS1); and
wherein the first motor shaft (12) can be mechanically functionally connected to the third motor shaft (1000) by means of the second motor coupling shifting element (MS2).

8. The drive device (10) according to claim 1, comprising:
a working hydraulics supply device (48);
a system hydraulics supply device (50); and
an auxiliary electric machine (HM) with an auxiliary motor shaft (900);
wherein the second motor shaft (14) is mechanically and functionally connected to the working hydraulics supply device (48); and
wherein the auxiliary motor shaft (900) is mechanically functionally connected to the system hydraulics supply device (50).

9. The drive device (10) according to claim 1, comprising:
a working hydraulics supply device (48); and
a system hydraulics supply device (50);
wherein the second motor shaft (14) is mechanically functionally connected to the working hydraulics supply device (48) and to the system hydraulics supply device (50).

10. The drive device (10) according to claim 9, comprising:
a second spur gear stage (602),
wherein the working hydraulics supply device (48) is permanently connected rotationally fixed to a shaft (600) of the first spur gear stage (44);
wherein the system hydraulics supply device (50) is mechanically functionally connected by way of the first spur gear stage (44) and the second spur gear stage (602) to the second motor shaft (14); and
wherein the first spur gear stage (44) and the second spur gear stage (602) have a common gearwheel (604).

11. The drive device (10) according to claim 6, wherein the first motor shaft (12) can be mechanically functionally connected to the second motor shaft (14) via the second spur gear stage (602) by means of the motor coupling shifting element (MS1).

12. The drive device (10) according to claim 1, wherein the planetary carrier (74) can be connected rotationally fixed to the sun gear (72) by means of the driving shifting element (FS).

13. The drive device (10) according to claim 1, wherein the driving planetary gearset (FP) is configured as a minus planetary gearset.

14. A working machine comprising a drive axle and the drive device (10) according to claim 1, wherein a torque can be transmitted by the first drive output shaft (16) to the drive axle.

15. The drive device (10) according to claim 5, comprising:
a first motor coupling shifting element (MS1); and
a second motor coupling shifting element (MS2);
wherein the third motor shaft (1000) can be mechanically and functionally connected to the second motor shaft (14) by means of the first motor coupling shifting element (MS1); and
wherein the first motor shaft (12) can be mechanically functionally connected to the third motor shaft (1000) by means of the second motor coupling shifting element (MS2).

16. The drive device (10) according to claim 10, wherein the first motor shaft (12) can be mechanically functionally connected to the second motor shaft (14) via the second spur gear stage (602) by means of the motor coupling shifting element (MS1).
